(19) United States
(12) Patent Application Publication
(10) Pub. No.: US 2009/0201469 A1
(43) Pub. Date: Aug. 13, 2009

(54) ILLUMINATION SYSTEM

(75) Inventors: Michel Cornelis Josephus Marie Vissenberg, Eindhoven (NL); Marcellinus Petrus Carolus Michael Krijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,054

(22) PCT Filed: Oct. 11, 2005
(86) PCT No.: PCT/IB2005/053336

§ 371 Date: Apr. 11, 2007

(30) Foreign Application Priority Data
Oct. 19, 2004 (EP) 04105157.4

(51) Int. Cl. G03B 21/28; G03B 21/14

(52) U.S. Cl. 353/97

(57) ABSTRACT

The present invention relates to an illumination system (10, 50) for a projection display device. The system comprises an integrator arrangement (14, 58) having at least one entrance aperture (16, 64), a light source (24, 54), and means (26, 56, 61) for directing light from the light source towards the at least one entrance aperture. The illumination system is characterized by a retro-reflector (34, 66) being arranged directly adjacent to said at least one entrance aperture. One advantage offered by the invention is that the efficiency of use of lumen output from the light source is increased. The invention also relates to a projection display device (80) comprising such illumination system.

The present invention relates to an illumination system comprising an integrator arrangement having at least one entrance aperture, a light source, and means for directing light from the light source towards the at least one entrance aperture. The invention also relates to a projection display device comprising such illumination system.

Projection displays based on LCOS or transmissive LCD modulator panels face problems with respect to light efficiency. This is because light is lost during the illumination process along the illumination path. One situation where light is lost is, in the light generating system of the projection display device, when light from a light source is to be focused onto an aperture of an integrator arrangement.

One example of this situation is when light from a light source is to be entered into a rod integrator of a light recycling system. Such a system is disclosed in for example the document WO02/096123. The system in WO02/096123 is based on both color and polarization recycling. For efficient recycling, an opening of the rod integrator through which light is to be coupled has to be as small as possible so that only a small amount of light is lost during the multiple forward and backward reflections inside the rod integrator. However, when using a small opening, not all of the light coming from the light source can be coupled into the rod integrator due to the finite spot size of the light that is focused on the annular opening. Thus, part of the light is lost and the efficiency of use of the lumen output is poor, in particular for small modulator panels where the light guiding means size becomes comparable to the spot size.

Another example of a situation where light is lost in the process of focusing light onto an aperture of an integrator arrangement is when light is to be coupled into a polarization conversion system (PCS). PCSs are utilized to generate polarized light in projection display devices. In the PCS, light from a light source is focused on a number of slits in a mask covering the PCS. However, part of the light may not be well focused onto the slits and will therefore be lost. Thus, the efficiency of use of the lumen output is poor. An example of a PCS is described in the document U.S. Pat. No. 6,535,334.

It is an object of the present invention to provide an improved illumination system which makes efficient use of the available light.

This and other objects that will be evident from the following description are achieved by means of an illumination system of the kind mentioned by way of introduction, further comprising a retro-reflector being arranged directly adjacent to the at least one entrance aperture.

The invention is based on the understanding that by having a retro-reflector directly adjacent to the at least one entrance aperture of the integrator arrangement, any stray light from the light source, i.e. light not perfectly focused onto the entrance aperture, can be redirected back to the light source by the retro-reflector, whereby the light again can be directed towards the entrance aperture by the directing means. Thus, by means of the retro-reflector, light from the light source can be recycled. Without the retro-reflector, most of the stray light will not re-enter the light source, and will be lost without having another chance of being directed towards the entrance aperture.

Consequently, one advantage offered by the present invention is that the efficiency of use of lumen output from the light source is increased. The light output from the light source is expected to be doubled for small entrance apertures due to the effect of retro-reflecting stray light back to the light source.

Preferably, the retro-reflector is so arranged that the displacement of any light retro-reflected by the retro-reflector is in the order of, or less than, the size of the light source, for example in the order of the size of the arc of a UHP lamp, i.e. a few millimeters, in case such light source is used. If the displacement is larger, the retro-reflected light will miss the light source on its way back, and will not be refocused onto the entrance aperture. The displacement can be achieved by adapting the size of the retro-reflecting structures of the retro-reflector, whereby the displacement of light is in the order of the size of the retro-reflecting structures.

The retro-reflecting structures can for example be an array of prism-like structures or an array of lenslets arranged in front of a reflector. Alternatively, the retro-reflector can be realized by indentations in a regular reflector.

In one embodiment of the invention, the integrator arrangement comprises a rod integrator provided with said at least one entrance aperture, and the directing means comprises a reflector for directing light from the light source towards the at least one entrance aperture for coupling light into said rod integrator. Preferably, the retro-reflector essentially surrounds the at least one entrance aperture so that a major part of the stray light can be redirected back to the light source. Also preferably, the rod integrator is utilized for light recycling, whereby the illumination system further comprises means, provided at the opposite end of the rod integrator in relation to the at least one entrance aperture, for selecting a portion of light and for reflecting it back into the rod integrator for recycling. The part of light not reflected is transmitted through the selecting means. In such a recycling system, when utilizing a retro-reflector for redirecting stray light back to the light source so that the light gets another chance of being coupled into the rod integrator, a gain in light output of about 20% compared to prior art solutions is expected.

The selecting means can for example be a color filter array, such as a color wheel, or a reflective polarizer. In the former case, a certain filter transmits one color and reflects the remaining colors, i.e. “color recycling”. In the latter case, light having a certain predetermined polarization is transmitted, while light having other polarization is reflected back into the rod integrator, i.e. “polarization recycling”. The reflective polarizer is preferably accompanied by a quarter wave plate so that light having “wrong” polarization can obtain the wanted predetermined polarization. The color filter array and the reflective polarizer can also be utilized in combination in order to increase the efficiency of the illumination system.

In another embodiment of the present invention, the integrator arrangement comprises a mask having at least one slit constituting the at least one entrance aperture, and the directing means comprises a reflector and a first integrator lens array for directing light from the light source towards the at least one slit. The retro-reflector can then be arranged on respective sides of each slit. Preferably, the integrator arrangement according to this embodiment of the invention constitutes a part of a polarization conversion system (PCS).

According to another aspect of the invention, a projection display device is provided, which projection display device comprises an illumination system according to the above description. The projection display device further comprises at least one modulator panel for modulating light outputted from the illumination system and means for projecting light from the at least one modulator panel onto a projection screen.

These and other aspects of the present invention will be described in more detail in the following, with reference to the appended figures showing presently preferred embodiments.

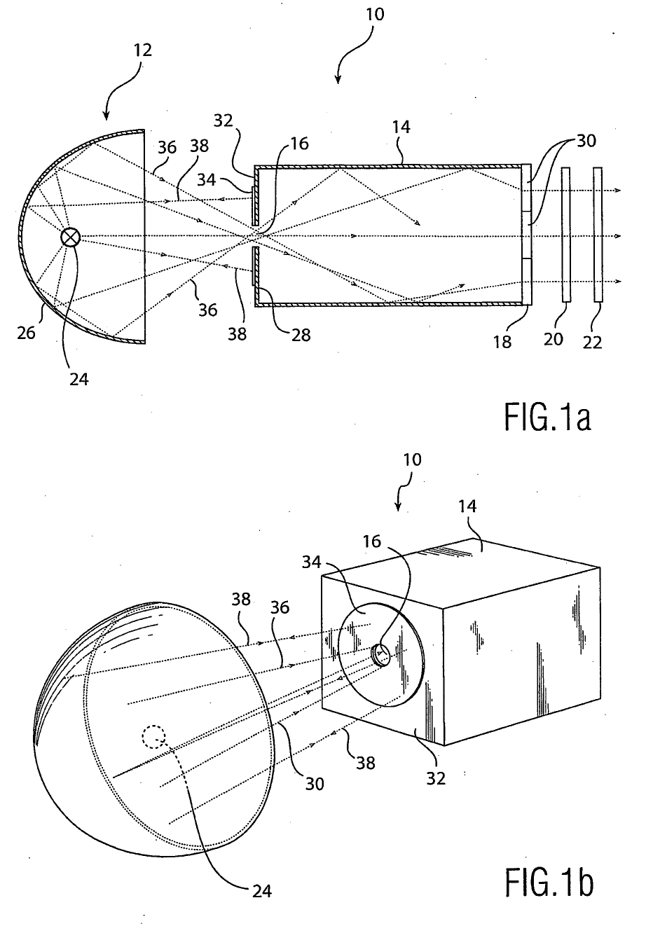

FIG. 1a is a schematic side view of an illumination system according to one embodiment of the present invention,

FIG. 1b is a schematic perspective view of the illumination system shown in FIG. 1a,

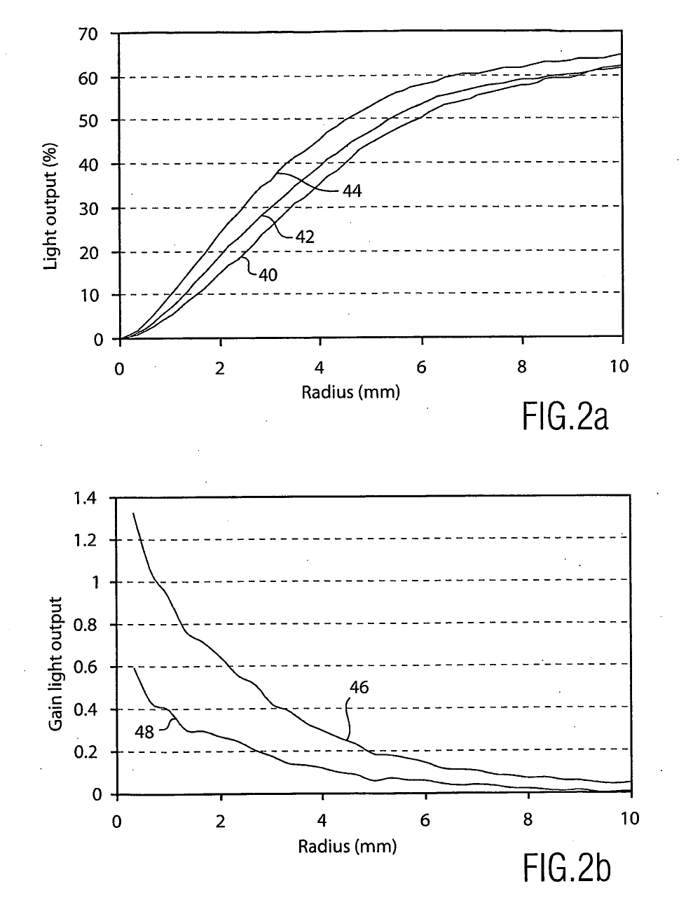

FIGS. 2a-2b are graphs showing change in light output for the light source of FIGS. 1a-1b,

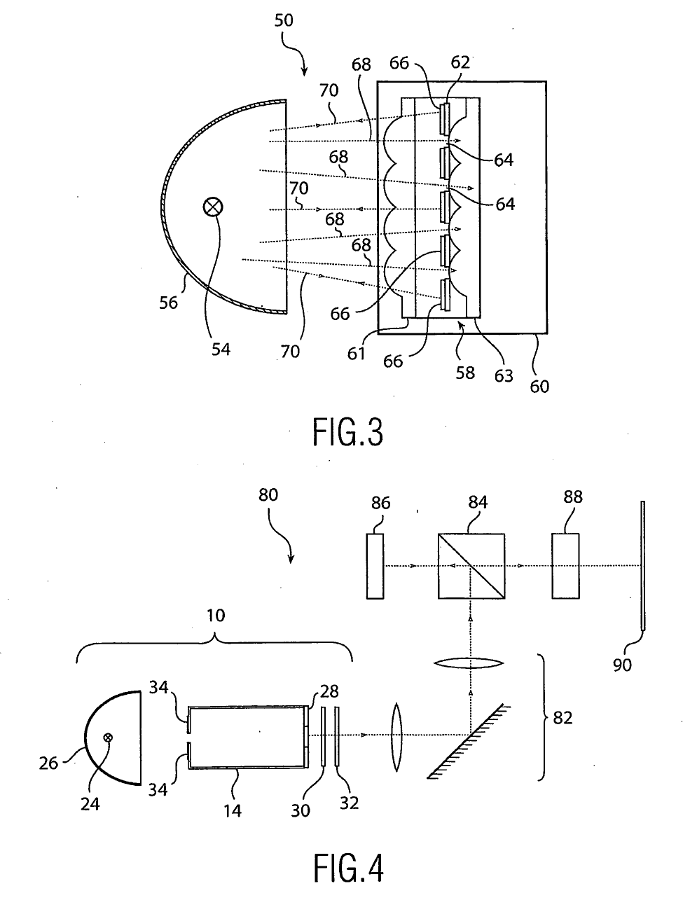

FIG. 3 is a schematic side view of an illumination system according to another embodiment of the present invention,

FIG. 4 is a schematic side view of a projection display device comprising an illumination system according to the invention,

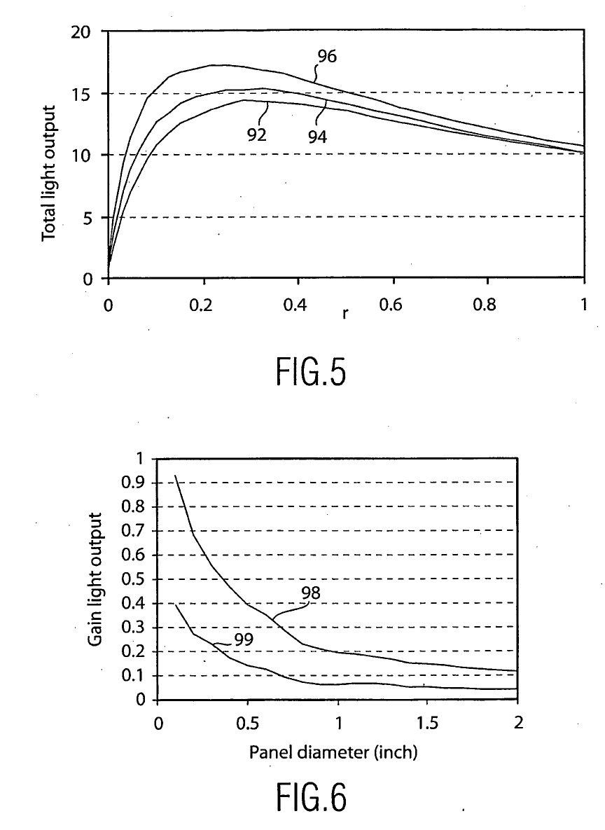

FIG. 5 is a graph showing the light output efficiency for an illumination system according to one embodiment of the invention, and

FIG. 6 is a graph showing the gain in light output for different modulator panel sizes.

FIGS. 1a-1b show an illumination system 10 which is similar to the system described in WO02/096123. The illumination system 10 comprises, in this order, a light source 24, a rod integrator 14 having at one end an entrance aperture 16, a color wheel 18, and a quarter wave plate 20 and a reflective polarizer 22.

The light source 24, e.g. a UHP lamp, is arranged with a reflector 26. Preferably, the reflector 26 is an ellipsoid reflector, whereby the light source 24 is positioned in one focal point and the entrance aperture 16 of the rod integrator 14 in another focal point.

The rod integrator 14 can be a bare, polished glass or PMMA rod, whereby light inside the integrator rod can be reflected at the glass-air interface (i.e. at the inner walls of the rod) by total internal reflection.

The color wheel 18, which is arranged at the opposite end of the rod integrator 14 in relation to the entrance aperture 16, comprises a plurality of color filters 30 corresponding to for example the colors red, green and blue. A red color filter, for example, transmits red light and reflects the remaining colors, i.e. green and blue.

The reflective polarizer 22 is adapted to transmit light having a certain predetermined polarization and to reflect light having other “wrong” polarization.

According to the invention, the outer entrance surface 32 of the rod integrator 14 is provided with a retro-reflector 34 surrounding the entrance aperture 16. As can be seen in FIG. 1b, the retro-reflector 34 partly covers the outer surface 32. However, the retro-reflector 34 can alternatively cover the entire outer surface 32 (except for the entrance aperture 16). The retro-reflector 34 is adapted to reflect incoming light in the direction of incidence. The retro-reflector 34 can be constituted by for example a retro-reflecting surface or coating, and can be constructed in various ways, as the skilled persons realize.

Upon operation of the illumination system 10, some light 36 from the light source 24 will be focused onto the entrance aperture 16 and coupled into the rod integrator 14, while some light 38 will not fall onto the entrance aperture due to imperfect focus of the light source 24, as discussed in the background above.

Most stray light 38, i.e. light not falling onto the entrance aperture, is received by the retro-reflector 34 surrounding the entrance aperture. Due the retro-reflector's characteristic of reflecting incoming light in the direction of incidence, the stray light is redirected back to the light source 24 and reflector 26. The light redirected back to the light source 24 will again be focused onto the entrance aperture and will have another chance of being coupled into the rod integrator.

Thus, light from the light source not being focused onto the entrance aperture, can be recycled by means of the retro-reflector, which increases the efficiency of use of the lumen output, as indicated in FIGS. 2a-2b. FIG. 2a is a graph showing the percentage of the light generated by a UHP lamp that falls onto the circular entrance aperture, as a function of the aperture radius. The situation where all the stray light is absorbed by the entrance surface is indicated by the curve 40. It is observed that the light output increases with increasing aperture radius, but saturates for larger values of the radius, when the complete light spot fits on the entrance aperture. The remaining light losses of about 40% are due to, for example, absorption at the ellipsoid reflector or scattering by lamp parts in the wrong direction. When the stray light is reflected back to the light source and reflector by a conventional reflective mirror, the total amount of light falling onto the entrance aperture increases by a few percent, as indicated by the curve 42. A significantly larger gain in light output is found when the stray light is retro-reflected to the light source, as indicated by the curve 44. The relative gain in light output from the light source (compared to the case when stray light is absorbed) by retro-reflecting stray light back to the light source, as a function of entrance aperture radius, is indicated in FIG. 2b by the curve 46. The curve 48 indicates the situation when a regular reflector is used. It is to be noted from FIG. 2b that the light output is doubled for small entrance apertures, given a certain size of the light source, while the effect of retro-reflecting stray light to the light source is decreasing for large targets.

Returning to FIGS. 1a-1b, the light that is coupled into the rod integrator 14 is guided towards the color wheel 18 and the quarter wave plate 20 and a reflective polarizer 22. At the color wheel 18, each color filter transmits a certain color, while the remaining light is reflected back into the rod integrator. Also light having “wrong” polarization is reflected back into the rod integrator 14 by the reflective polarizer 20. The light reflected back into the rod integrator 14 is then reflected back towards the color wheel 18 and the reflective polarizer 22 by the reflective inner surface 28, which gives the light another chance of passing the color wheel 18 and reflective polarizer 22. This recycling based on color and polarization is known from prior art.

Thus, the illumination system 10 provides light recycling both at the light source and at the rod integrator. It should further be noted that the aspects of color recycling and polarization recycling can be used separately in different illumination systems.

FIG. 3 shows schematically an illumination system 50 according to another embodiment of the present invention. The illumination system 50 comprises a light source 54, a reflector 56, and an integrator arrangement 58. The integrator arrangement 58 forms a part of a polarization conversion system (PCS) 60 and comprises a first and second integrator lens array 61 and 63, and a mask 62 having a plurality of slits 64, which slits constitute entrance apertures. The slits 64 are adapted to receive light which is to be polarized by the PCS.

According to the invention, the mask 62 is further covered by a retro-reflector 66 on respective sides of each slit 64, as indicated in FIG. 3.

Since the operation of a PCS is well known for the person skilled in the art, only the operation involving the retro-reflector 66 according to the invention will be described in the following.

Upon operation of the illumination system 50, some light 68 from the light source 54 will be focused on the slits 64 by means of the reflector 56 and the first integrator lens array 61, while some light 70 will not fall onto the slits 64 due to imperfect.

Most stray light 68, i.e. light not falling onto the slits 64, is received by the retro-reflector 66 arranged directly adjacent to the slits 64. Due the retro-reflector's characteristic of reflecting incoming light in the direction of incidence, the stray light is redirected back to the light source 54 and reflector 56. The light redirected back to the light source 54 will again be focused onto the slits 64 and will have another chance of passing the slits 64 of the mask 62.

Thus, light from the light source 54 not being focused onto the slits 64 can be recycled by means of the retro-reflector 66, which increases the efficiency of use of the lumen output.

FIG. 4 is a schematic view of a projection display device 80 comprising an illumination system 10 according to the present invention. In FIG. 4, the illumination-system 10 comprises a light source 24 and reflector 26, a rod integrator 14 provided with a retro-reflector 34, a color wheel 28, and a quarter wave plate 20 and a polarizing plate 32. However, the illumination system may be of any type described above.

In addition to the inventive illumination system 20, the projection display device 80 comprises a relay system of transfer lenses 82, a polarizing beam splitter 84, a reflective modulator panel 86 (such as an LCOS or DMD), and a projection lens 88.

Upon operation of the projection display device 80, light outputted by the illumination system 10 is transferred by the relay system 82 to the polarizing beam splitter 84, which in turn images the light onto the panel 86. The light reflected by the panel 86 is then focused by the projection lens 88 onto a projection screen 90 in order to form a projected image.

The combined efficiency of color recycling, polarization recycling, and light recycling at the light source (by means of the retro-reflector) for the illumination system 10 of FIGS. 1a-1b is shown in FIG. 5 as function of aperture ratio r (i.e. the ratio of the area of the entrance aperture to the area of the rod integrator cross-section). The size of the entrance aperture of the rod integrator depends on the size of the rod integrator and on the recycling efficiency, as discussed in the background above. FIG. 5 is based on a one inch diameter 16:9 modulator panel, and the situations where the stray light is absorbed, reflected by a conventional reflective mirror, and reflected by a retro-reflector, are indicated by the curves 92, 94 and 96, respectively. Clearly, there is an optimum value for a certain aperture ratio r. It should also be noted that the total light output increases more than 20% when using a retro-reflector instead of a conventional reflector or absorber. Further, the optimum efficiency increases and shifts to smaller r when stray light is retro-reflected to the lamp. Also, the gain in light output is expected to increase for smaller modulator panel sizes.

Further, the relative gain in light output (compared to the case when stray light is absorbed) by retro-reflecting stray light back to the light source and reflector, as a function of modulator panel size, is indicated in FIG. 6 by the curve 98. The curve 99 indicates the situation when a regular reflector is used. Compared to the case without reflection, the retro-reflector improves the light output by 10-20% for panel sizes larger than 1 inch diagonal, and by several tens of percents for smaller panel sizes.

The invention is not limited to the embodiments described above. Those skilled in the art will recognize that variations and modifications can be made without departing from the scope of the invention as claimed in the accompanying claims. For example, the projection display system can comprise a plurality of modulator panels.

1. An illumination system (10, 50) for a projection display device, said system comprising:
an integrator arrangement (14, 58) having at least one entrance aperture (16, 64),
a light source (24, 54), and
means (26, 56, 61) for directing light from said light source towards said at least one entrance aperture,
characterized by:
a retro-reflector (34, 66) being arranged directly adjacent to said at least one entrance aperture (16, 64).

2. A system according to claim 1, wherein said retro-reflector (34, 66) is so arranged that the displacement of any light retro-reflected by said retro-reflector is in the order of the size of the light source (24, 54), or less.

3. A system according to claim 1, wherein said integrator arrangement comprises a rod integrator (14) provided with said at least one entrance aperture (16), and wherein said directing means comprises a reflector (26) for directing light from the light source (24) towards said at least one entrance aperture (16) for coupling light into said rod integrator.

4. A system according to claim 3, wherein the retro-reflector (34) essentially surrounds the at least one entrance aperture (16).

5. A system according to claim 3, further comprising means (18, 22), provided at the opposite end of said rod integrator (14) in relation to said at least one entrance aperture (16), for selecting a portion of light and for reflecting said portion back into the rod integrator.

6. A system according to claim 5, wherein said selecting means comprises a color filter array (18).

7. A system according to claim 5, wherein said selecting means comprises a reflective polarizer (22).

8. A system according to claim 1, wherein said integrator arrangement (58) comprises a mask (62) having at least one slit (64) constituting said at least one entrance aperture, and wherein said directing means comprises a reflector (56) and a first integrator lens array (61) for directing light from the light source (54) towards said at least one slit (64).

9. A system according to claim 8, wherein said retro-reflector (66) is arranged on respective sides of each slit (64).

10. A projection display device (80), comprising:
an illumination system according to claim 1,
at least one modulator panel (86) for modulating light outputted from said illumination system, and
means (88) for projecting light from said at least one modulator panel onto a projection screen (90).
